(19) United States
(12) Patent Application Publication
(10) Pub. No.: US 2021/0079135 A1
(43) Pub. Date: Mar. 18, 2021

(54) RUBBER COMPOSITION

(71) Applicant: COMPAGNIE GENERALE DES ETABLISSEMENTS MICHELIN, Clermont-Ferrand (FR)

(72) Inventors: Julien THUILLIEZ, Clermont-Ferrand Cedex 9 (FR); Emma MORESO, Clermont-Ferrand Cedex 9 (FR); Vincent LAFAQUIERE, Clermont-Ferrand Cedex 9 (FR)

(73) Assignee: COMPAGNIE GENERALE DES ETABLISSEMENTS MICHELIN, Clermont-Ferrand (FR)

(21) Appl. No.: 16/620,257

(22) PCT Filed: Jun. 6, 2018
(86) PCT No.: PCT/FR2018/051307

§ 371 Date: Dec. 6, 2019

(30) Foreign Application Priority Data
Jun. 8, 2017 (FR) 17/55109

(51) Int. Cl. C08F 210/02; C08K 3/36; B60C 1/00; B60C 11/00

(52) U.S. Cl. CPC C08F 210/02; C08K 3/36; B60C 2011/0025; B60C 11/0008; B60C 1/0016

(57) ABSTRACT

A rubber composition which comprises at least one reinforcing inorganic filler and a highly saturated elastomer comprising 1,3-diene units and ethylene units and bearing, at the chain end, a functional group F¹ which is a silanol or alkoxysilane function is provided. The ethylene units represent more than 50 mol % of all the monomer units of the elastomer. The rubber composition has an improved hysteresis/stiffness compromise.

This application is a 371 national phase entry of PCT/FR2018/051307 filed on 6 Jun. 2018, which claims benefit of French Patent Application No. 1755109, filed 8 Jun. 2017, the entire contents of which are incorporated herein by reference for all purposes.

### BACKGROUND

### 1. Technical Field

The present invention relates to a rubber composition that can be used in particular for tire manufacture, which comprises at least one reinforcing inorganic filler and a diene elastomer which is functional and highly saturated, since it is rich in ethylene units.

### 2. Related Art

A tire has to meet, in a known way, a large number of often conflicting technical requirements, including low rolling resistance, high wear resistance, high dry grip and high wet grip. This compromise in properties, in particular from the viewpoint of the rolling resistance and the wear resistance, has been able to be improved in recent years with regard to energy-saving “Green Tires”, intended in particular for passenger vehicles, by virtue in particular of the use of novel low-hysteresis rubber compositions having the characteristic of being reinforced predominantly by highly dispersible silicas (HDSs), capable of rivalling, from the viewpoint of the reinforcing power, conventional tire-grade carbon blacks.

Tire rubber compositions generally comprise elastomers rich in diene units such as polybutadienes, polyisoprenes and copolymers of 1,3-butadiene or isoprene and styrene. Replacing these elastomers rich in diene units, in these same compositions, with diene elastomers rich in ethylene units is accompanied both by a reduction in hysteresis of the rubber composition and by an increase in the stiffness thereof, which is expressed by a modification of the performance compromise between the rolling resistance and the wear. Reference may for example be made to document WO 2014114607. These diene elastomers rich in ethylene units also have the property of giving the rubber compositions an improved wear resistance performance under extreme conditions, as is described in document WO 2016012259.

To further improve the rolling resistance performance, it is known to use elastomers that have one or more functions which interact with the reinforcing filler. Functional elastomers may be prepared by anionic polymerization, the functionalization taking place during the initiation reaction or termination reaction. The modification of the ends of the polymer chains produced by anionic polymerization rests upon the living nature of the polymer chains, the living nature being expressed by the absence of transfer reaction and termination reaction during the polymerization reaction. Living polymerization is also characterized by the fact that a single polymer chain is produced per mole of initiator or per metal. The chain-end modification of a polymer by an alkoxysilane or silanol function is much less described for polymers synthesized by catalytic polymerization using a heterogeneous Ziegler-Natta catalytic system. By way of example, mention may be made of document WO 2001034658 which describes the functionalization of a polybutadiene having a high content of cis-1,4-bonds prepared by coordination catalysis using a catalytic system comprising a neodymium carboxylate. But these synthetic pathways do not lead to diene elastomers rich in ethylene units.

Polymerization by means of a catalytic coordination system comprising a metallocene makes it possible to attain ethylene-rich diene copolymers. But this polymerization is based on chemistry different from anionic polymerization and from polymerization by Ziegler-Natta catalysis. A first difference relates to the catalytic system, for example described in documents EP 1 092 731 B1, WO 2004035639 and EP 1 954 706 B1 which is typically composed of a metallocene and of a cocatalyst, an organomagnesium compound. A second difference relates to the reactions involved which comprise numerous transfer reactions between the metal of the metallocene and the magnesium of the cocatalyst and which also enable the production of a large number of copolymer chains via metallocene metal. A third difference relates to the polymer chains produced which comprise both unsaturated units, such as diene units, and ethylenic saturated units. Another difference relates to the chemical structure of the chain end to be modified, which structure results from the very specific polymerization mechanism.

Reference may for example be made to the document ACS Catalysis, 2016, Volume 6, Issue 2, pages 1028-1036. Owing to the specificity of the species and reactions involved in the synthesis of these copolymers, to date no process exists that enables the modification of these copolymers at the chain end and subsequently a reduction in hysteresis of silica-reinforced rubber compositions containing these copolymers.

It has been proposed, in document WO 2016012258, to modify, after the synthesis thereof, diene elastomers rich in ethylene units by functionalizing them with associative groups by a reaction of grafting a 1,3-dipolar compound to the diene units of the elastomers. The modified elastomers give the rubber composition a reduced hysteresis. However, the stiffness of the composition remains as high as before the modification, which may make them unsuitable for use in a semi-finished article for a tire.

### SUMMARY

The objective of the present invention is to propose a low-hysteresis rubber composition which comprises a diene elastomer rich in ethylene units while reducing its stiffness. This objective is achieved in that the inventors have discovered that such a compromise between stiffness and hysteresis could be obtained by the modification of the chain end of the diene elastomer rich in ethylene units by a silanol or alkoxysilane function.

Thus, a first subject of the invention is a rubber composition which comprises at least one reinforcing inorganic filler and a highly saturated elastomer comprising 1,3-diene units and ethylene units and bearing, at the chain end, a silanol or alkoxysilane function, the ethylene units representing more than 50 mol % of all the monomer units of the elastomer.

Another subject of the invention is a semi-finished article which comprises a rubber composition in accordance with the invention.

A further subject of the invention is a tire which comprises a rubber composition in accordance with the invention or a semi-finished article in accordance with the invention.

### I. DETAILED DESCRIPTION OF EXAMPLE EMBODIMENTS

Any interval of values denoted by the expression “between a and b” represents the range of values greater than “a” and less than “b” (that is to say, limits a and b excluded), whereas any interval of values denoted by the expression “from a to b” means the range of values extending from “a” up to “b” (that is to say, including the strict limits a and b). The abbreviation “phr” means parts by weight per hundred parts of elastomer (of the total of the elastomers, if several elastomers are present).

The compounds mentioned in the description can be of fossil or biobased origin. In the latter case, they can partially or completely result from biomass or be obtained from renewable starting materials resulting from biomass. Elastomers, plasticizers, fillers, and the like, are concerned in particular.

In the present application, “all the monomer units of the elastomer” is understood to mean all the constituent repeat units of the elastomer which result from the insertion of the monomers into the elastomer chain by polymerization.

The elastomer useful for the requirements of the invention is an elastomer which comprises ethylene units resulting from the polymerization of ethylene. In a known way, the expression “ethylene unit” refers to the —(CH₂—CH₂)— unit resulting from the insertion of ethylene into the elastomer chain. The elastomer rich in ethylene units is described as a highly saturated elastomer, since the ethylene units represent more than 50 mol % of all the monomer units of the elastomer. Preferably, they represent more than 60 mol % of all the monomer units of the elastomer. More preferentially, the content of ethylene units in the elastomer is at least 65 mol % of all the monomer units of the elastomer.

The elastomer useful for the requirements of the invention also comprises 1,3-diene units resulting from the polymerization of a 1,3-diene. In a known way, the expression “1,3-diene unit” refers to the units resulting from the insertion of the 1,3-diene by a 1,4-insertion, a 2,1-insertion or a 3,4-insertion in the case of isoprene. The 1,3-diene units are those, for example, of a 1,3-diene having from 4 to 12 carbon atoms, such as 1,3-butadiene, isoprene, 1,3-pentadiene or an aryl-1,3-butadiene. Preferably, the 1,3-diene is 1,3-butadiene.

According to a first embodiment of the invention, the elastomer contains UD units of formula (I) and may contain UE units of formula (II).

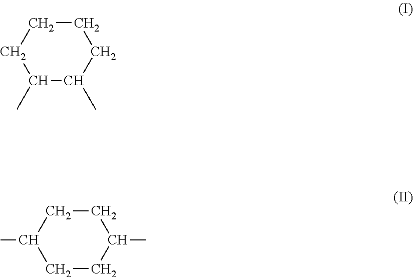

Preferably, the elastomer contains the following UA, UB, UC, UD and UE units distributed randomly according to the molar percentages indicated below:
UA) —CH₂—CH₂— according to a molar percentage of m %
UB) —CH₂—CH═CH—CH₂— according to a molar percentage of n %
UC) —CH₂—CH(CH═CH₂)— according to a molar percentage of o %

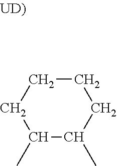

according to a molar percentage of p %

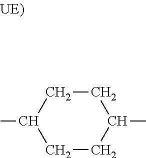

according to a molar percentage of q %
   m, n, o, p and q being numbers ranging from 0 to 100,
   m>50
   n+o>0
   p>0
   q≥0,
   the respective molar percentages of m, n, o, p and q being calculated on the basis of the sum of m+n+o+p+q, which is equal to 100.

More preferentially,
0<o+p≤25
o+p+q≥5
n+o>0
q≥0,
the respective molar percentages of m, n, o, p and q being calculated on the basis of the sum of m+n+o+p+q, which is equal to 100.

Even more preferentially, the elastomer has at least one of the following criteria, and preferentially all of them:
m≥65
n+o+p+q≥15, preferably n+o+p+q≥20
12≥p+q≥2
1≥n/(o+p+q)
when q is non-zero, 20≥p/q≥1.

Advantageously, q is equal to 0.

According to a second embodiment of the invention, the elastomer contains trans-1,4-units which represent more than 80 mol % of the 1,3-diene units of the elastomer. In other words, the 1,3-diene units in the elastomer contain more than 80 mol % of trans-1,4-units according to embodiment. As is well known, the trans-1,4-units are 1,4-units which have the trans configuration.

According to the second embodiment, the elastomer may comprise UD units of formula (I), in which case the UD units preferably represent less than 1 mol % of all the monomer units of the elastomer.

According to a variant of the second embodiment, the elastomer comprises α-monoolefin units distributed randomly within the elastomer. According to this variant, the elastomer is preferentially a terpolymer of 1,3-butadiene, ethylene and an α-monoolefin. An alpha-olefin (α-olefin) is understood to mean a terminal olefin, that is to say that it contains the vinyl group of formula —CH═CH₂. A monoolefin is understood to mean a monomer which contains a single carbon-carbon double bond, apart from those of the benzene ring of the aromatic group. The α-monoolefin may be aliphatic; in this regard, mention may be made of aliphatic α-monoolefins having from 3 to 18 carbon atoms, such as propene, 1-butene, 1-hexene, 1-octene, 1-hexadecene or mixtures thereof. The α-monoolefin may also be an aromatic α-monoolefin. Typically, the aromatic α-monoolefin is of formula CH₂═CH—Ar, in which the symbol Ar represents an aromatic group. The aromatic group can be a substituted or unsubstituted phenyl. Suitable as aromatic α-monoolefin are styrene, styrenes substituted by one or more alkyl groups in the para, meta or ortho positions, or mixtures thereof.

The elastomer useful for the requirements of the invention is very preferentially a copolymer of ethylene and of 1,3-butadiene.

Whatever the embodiment of the invention, including in the variants, the elastomer useful for the requirements of the invention is preferentially random.

According to the invention, the silanol or alkoxysilane function is located at the end of the chain of the elastomer. In present application, the alkoxysilane or silanol function borne at one of the ends is referred to in the present application by the name the functional group F¹. Preferably, it is attached directly via a covalent bond to the terminal unit of the elastomer, which means to say that the silicon atom of the function is directly bonded, covalently, to a carbon atom of the terminal unit of the elastomer. The terminal unit to which the functional group F¹ is directly attached preferably consists of a methylene bonded to an ethylene unit or to a UD unit, the Si atom being bonded to the methylene. A terminal unit is understood to mean the last unit inserted in the copolymer chain by copolymerization, which unit is preceded by a penultimate unit, which is itself preceded by the antepenultimate unit.

According to a first variant of the invention, the functional group F¹ is of formula (III-a)

Si(OR¹)_{3-f}(R²)_{f} (III-a)
the R¹ symbols, which are identical or different, representing an alkyl,
the R² symbols, which are identical or different, representing a hydrogen atom, a hydrocarbon chain or a hydrocarbon chain substituted by a chemical function F²,
f being an integer ranging from 0 to 2.

In the formula (III-a), the R¹ symbols are preferentially an alkyl having at most 6 carbon atoms, more preferentially a methyl or an ethyl, more preferentially still a methyl.

If 3−f is greater than 1, the R¹ symbols are advantageously identical, in particular methyl or ethyl, more particularly methyl.

According to a second variant of the invention, the functional group F¹ is of formula (III-b)

Si(OH)(R²)₂, (III-b)
the R² symbols, which are identical or different, representing a hydrogen atom, a hydrocarbon chain or a hydrocarbon chain substituted by a chemical function F².

Among the hydrocarbon chains represented by the R² symbols in the formulae (III-a) and (III-b), mention may be made of alkyls, in particular those having 1 to 6 carbon atoms, preferentially methyl or ethyl, more preferentially methyl.

Among the hydrocarbon chains substituted by a chemical function F² represented by the R² symbols in the formulae (III-a) and (III-b), mention may be made of alkanediyl chains, in particular those comprising at most 6 carbon atoms, very particularly the 1,3-propanediyl group, the alkanediyl group bearing a substituent, the chemical function F², in other words one valence of the alkanediyl chain for the function F², the other valence for the silicon atom of the silanol or alkoxysilane function.

In the formulae (III-a) and (III-b), a chemical function F² is understood to mean a group which is different from a saturated hydrocarbon group and which may participate in chemical reactions. Among the chemical functions which may be suitable, mention may be made of the ether function, the thioether function, the primary, secondary or tertiary amine function, the thiol function, the silyl function. The primary or secondary amine or thiol functions may be protected or may not be protected. The protecting group of the amine and thiol functions is for example a silyl group, in particular trimethylsilyl or tert-butyldimethylsilyl group.

Preferably, the chemical function F² is a primary, secondary or tertiary amine function or a thiol function, the primary or secondary amine or thiol function being protected by a protecting group or being unprotected.

Preferably, the R² symbols, which are identical or different, represent an alkyl having at most 6 carbon atoms or an alkanediyl chain having at most 6 carbon atoms and substituted by a chemical function F² in the formulae (III-a) and (III-b).

Mention may be made, as functional group F¹, of the dimethoxymethylsilyl, dimethoxyethylsilyl, diethoxymethysilyl, diethoxyethysilyl, 3-(N,N-dimethylamino)propyldimethoxysilyl, 3-(N,N-dimethylamino)propyldiethoxysilyl, 3-aminopropyldimethoxysilyl, 3-aminopropyldiethoxysilyl, 3-thiopropyldimethoxysilyl, 3-thiopropyldiethoxysilyl, methoxydimethylsilyl, methoxydiethylsilyl, ethoxydimethysilyl, ethoxydiethysilyl, 3-(N,N-dimethylamino)propylmethoxymethylsilyl, 3-(N,N-dimethylamino)propylmethoxyethylsilyl, 3-(N,N-dimethylamino)propylethoxymethylsilyl, 3-(N,N-dimethylamino)propylethoxyethylsilyl, 3-aminopropylmethoxymethylsilyl, 3-aminopropylmethoxyethylsilyl, 3-aminopropylethoxymethylsilyl, 3-aminopropylethoxyethylsilyl, 3-thiopropylmethoxymethylsilyl, 3-thiopropylethoxymethylsilyl, 3-thiopropylmethoxyethylsilyl and 3-thiopropylethoxyethylsilyl groups.

Mention may also be made, as functional group F¹, of the silanol form of the functional groups mentioned above which contain one and only one ethoxy or methoxy function, it being possible for the silanol form to be obtained by hydrolysis of the ethoxy or methoxy function. In this regard, the dimethylsilanol, diethylsilanol, 3-(N,N-dimethylamino)propylmethylsilanol, 3-(N,N-dimethylamino)propylethylsilanol, 3-aminopropylmethylsilanol, 3-aminopropylethylsilanol, 3-thiopropylethylsilanol and 3-thiopropylmethylsilanol groups are suitable.

Mention may also be made, as functional group F¹, of the functional groups whether they are in the alkoxy or silanol form, which have been mentioned above and which comprise an amine or thiol function in a form protected by a silyl group, in particular trimethylsilyl or tert-butyldimethylsilyl group.

According to one very preferential embodiment of the invention, the functional group F¹ is of formula (III-a) in which f is equal to 1. According to this very preferential embodiment, the groups for which R¹ is a methyl or an ethyl, such as for example the dimethoxymethylsilyl, dimethoxyethylsilyl, diethoxymethysilyl, diethoxyethysilyl, 3-(N,N-dimethylamino)propyldimethoxysilyl, 3-(N,N-dimethylamino)propyldiethoxysilyl, 3-aminopropyldimethoxysilyl, 3-aminopropyl-diethoxysilyl, 3-thiopropyldimethoxysilyl and 3-thiopropyldiethoxysilyl groups, are very particularly suitable. Also suitable are the protected forms of the amine or thiol function of the last 4 functional groups mentioned in the preceding list, protected by a silyl group, in particular trimethylsilyl or tert-butyldimethylsilyl group.

According to one even more preferential embodiment of the invention, the functional group F¹ is of formula (III-a) in which f is equal to 1 and R¹ is a methyl. According to this even more preferential embodiment, the dimethoxymethylsilyl, dimethoxyethylsilyl, 3-(N,N-dimethylamino)propyldimethoxysilyl, 3-aminopropyldimethoxysilyl and 3-thiopropyldimethoxysilyl groups, and also the protected forms of the amine or thiol function of 3-aminopropyldimethoxysilyl or 3-thiopropyldimethoxysilyl, protected by a trimethylsilyl or a tert-butyldimethylsilyl, are very particularly suitable.

The elastomer useful for the requirements of the invention may be prepared by a process which comprises the following steps (a) and (b), and if need be step (c):
a) the copolymerization of a monomer mixture in the presence of a catalytic system comprising an organomagnesium compound and a metallocene,
b) the reaction of a functionalizing agent with the polymer obtained in step a),
c) if need be a hydrolysis reaction.

Step a) is a copolymerization of the mixture of the monomers. The monomer mixture is a mixture of ethylene, of 1,3-diene, preferably of 1,3-butadiene, and optionally of α-monoolefin. The copolymerization may be carried out in accordance with patent applications EP 1 092 731, WO 2004035639, WO 2007054223 and WO 2007054224 using a catalytic system composed of a metallocene and an organomagnesium compound which are used as catalyst and cocatalyst respectively.

A person skilled in the art adapts the polymerization conditions described in these documents so as to achieve the desired microstructure and macrostructure of the copolymer chain. According to any one of the embodiments of the invention, the molar ratio of the organomagnesium compound to the metal Met constituting the metallocene is preferably within a range extending from 1 to 100, more preferentially is greater than or equal to 1 and less than 10. The range of values extending from 1 to less than 10 is in particular more favourable for obtaining copolymers of high molar masses.

A person skilled in the art also adapts the polymerization conditions and the concentrations of each of the reactants (constituents of the catalytic system, monomers) depending on the equipment (tools, reactors) used for carrying out the polymerization and the various chemical reactions. As is known to a person skilled in the art, the copolymerization and the handling of the monomers, of the catalytic system and of the polymerization solvent(s) take place under anhydrous conditions and under an inert atmosphere. The polymerization solvents are typically aliphatic or aromatic hydrocarbon solvents.

Advantageously, the organomagnesium compound is butyloctylmagnesium or butylethylmagnesium and the metallocene is chosen from [{Me₂SiFlu₂Nd(μ-BH₄)₂Li(THF)}₂], [Me₂SiFlu₂Nd(μ-BH₄)₂Li(THF)], [Me₂SiFlu₂Nd(μ-BH₄)(THF)], [{Me₂SiFlu₂Nd(μ-BH₄)(THF)}₂], [Me₂SiFlu₂Nd(μ-BH₄)], [Me₂Si(C₅H₄)(C₁₃H₈)NdCl], [Me₂Si(C₅H₄)(C₁₃H₈)Nd(BH₄)₂Li(THF)], [Me₂Si(C₅H₄)(C₁₃H₈)Nd(BH₄)(THF)], the Flu symbol representing the C₁₃H₈ group.

Step b) consists in reacting a functionalizing agent with the copolymer obtained in step a) in order to functionalize the chain end of the copolymer. The functionalizing agent is a compound of formula (IV),

Si(Fc¹)_{4-g}(Rc²)_{g} (IV)
the Fc¹ symbols, which are identical or different, representing an alkoxy group or a halogen atom,
the Rc² symbols, which are identical or different, representing a hydrogen atom, a hydrocarbon chain or a hydrocarbon chain substituted by a chemical function Fc²,
g being an integer ranging from 0 to 2.

When the Fc¹ symbol represents an alkoxy group, the alkoxy group is preferably methoxy or ethoxy. When the Fc¹ symbol represents a halogen atom, the halogen atom is preferably chlorine.

According to one preferential embodiment of the invention, at least one of the Fc¹ symbols represents an alkoxy group, in particular methoxy or ethoxy. Advantageously, the functionalizing agent is then of formula (IV-1)

MeOSi(Fc¹)_{3-g}(Rc²)_{g} (IV-1)
the Fc¹ and Rc² symbols and g being as defined in the formula (IV).

According to one more preferential embodiment, at least two of the Fc¹ symbols represent an alkoxy group, in particular methoxy or ethoxy. Advantageously, the functionalizing agent is then of formula (IV-2)

(MeO)₂Si(Fc¹)_{2-g}(Rc²)_{g} (IV-2)
the Fc¹ and Rc² symbols and g being as defined in the formula (IV).

According to one even more preferential embodiment, at least three of the Fc′ symbols represent an alkoxy group, in particular methoxy or ethoxy. Advantageously, the functionalizing agent is then of formula (IV-3)

(MeO)₃Si(Fc¹)_{1-g}(Rc²)_{g} (IV-3)
the Fc¹ and Rc² symbols being as defined in the formula (IV) and g being an integer ranging from 0 to 1.

According to one even more advantageous embodiment, the functionalizing agent is of formula (IV-4).

(MeO)₃SiRc² (IV-4)
Rc² being as defined in formula (IV).

Among the hydrocarbon chains represented by the Rc² symbols in the formulae (III), (IV-1), (IV-2), (IV-3) and (IV-4), mention may be made of alkyls, preferably alkyls having at most 6 carbon atoms, more preferentially methyl or ethyl, better still methyl.

Among the hydrocarbon chains substituted by a chemical function Fc² which are represented by the Rc² symbols in the formulae (IV), (IV-1), (IV-2), (IV-3) and (IV-4), mention may be made of alkanediyl chains, preferably those comprising at most 6 carbon atoms, more preferentially the 1,3-propanediyl group, the alkanediyl group bearing a substituent, the chemical function Fc², in other words one valence of the alkanediyl chain for the function F², the other valence for the silicon atom of the silanol or alkoxysilane function.

In the formulae (IV), (IV-1), (IV-2), (IV-3) and (IV-4), a chemical function is understood to mean a group which is different from a saturated hydrocarbon group and which may participate in chemical reactions. A person skilled in the art understands that the chemical function Fc² is a group that is chemically inert with respect to the chemical species present in the polymerization medium. The chemical function Fc² may be in a protected form, such as for example in the case of the primary amine, secondary amine or thiol function. Mention may be made, as chemical function Fc², of the ether, thioether, protected primary amine, protected secondary amine, tertiary amine, protected thiol, and silyl functions. Preferably, the chemical function Fc² is a protected primary amine function, a protected secondary amine function, a tertiary amine function or a protected thiol function. As protecting groups of the primary amine, secondary amine and thiol functions, mention may be made of silyl groups, for example the trimethylsilyl and tert-butyldimethylsilyl groups.

g is preferably other than 0, which means that the functionalizing agent comprises at least one Si-Rc² bond.

Mention may be made, as functionalizing agent, of the compounds dimethoxydimethylsilane, diethoxydimethylsilane, dimethoxydiethylsilane, diethoxydiethylsilane, (N,N-dimethyl-3-aminopropyl)methyldimethoxysilane, (N,N-dimethyl-3-aminopropyl)methyldiethoxysilane, (N,N-dimethyl-3-aminopropyl)ethyldimethoxysilane, (N,N-dimethyl-3-aminopropyl)ethyldiethoxysilane, 3-methoxy-3,8,8,9,9-pentamethyl-2-oxa-7-thia-3,8-disiladecane, trimethoxymethylsilane, triethoxymethylsilane, trimethoxyethylsilane, triethoxyethylsilane, (N,N-dimethylaminopropyl)trimethoxysilane, (N,N-dimethylaminopropyl)triethoxysilane, (N-(3-trimethoxysilyl)propyl)-N-(trimethylsilyl)silanamine, (N-(3-triethoxysilyl)propyl)-N-(trimethylsilyl)silanamine and 3,3-dimethoxy-8,8,9,9-tetra methyl-2-oxa-7-thia-3,8-disiladecane, preferably dimethoxydimethylsilane, dimethoxydiethylsilane, (N,N-dimethyl-3-aminopropyl)methyldimethoxysilane, (N,N-dimethyl-3-aminopropyl)ethyldimethoxysilane, 3-methoxy-3,8,8,9,9-penta methyl-2-oxa-7-thia-3,8-disiladecanetrimethoxymethylsilane, trimethoxyethylsilane, (N,N-dimethylaminopropyl)trimethoxysilane, (N-(3-trimethoxysilyl)propyl)-N-(trimethylsilyl)silanamine and 3,3-dimethoxy-8,8,9,9-tetramethyl-2-oxa-7-thia-3,8-disiladecane, more preferentially trimethoxymethylsilane, trimethoxyethylsilane, (N,N-dimethylaminopropyl)trimethoxysilane, (N-(3-trimethoxysilyl)propyl)-N-(trimethylsilyl)silanamine and 3,3-dimethoxy-8,8,9,9-tetramethyl-2-oxa-7-thia-3,8-disiladecane.

The functionalizing agent is typically added to the polymerization medium resulting from step a). It is typically added to the polymerization medium at a degree of conversion of the monomers chosen by a person skilled in the art depending on the desired macrostructure of the elastomer. Since step a) is generally carried out under ethylene pressure, a degassing of the polymerization reactor may be carried out before the addition of the functionalizing agent. The functionalizing agent is added under inert and anhydrous conditions to the polymerization medium, maintained at the polymerization temperature. Use is typically made of from 0.25 to 10 mol of functionalizing agent per 1 mol of cocatalyst, preferably of from 2 to 4 mol of functionalizing agent per 1 mol of cocatalyst.

The functionalizing agent is brought into contact with the polymerization medium for a time sufficient to enable the functionalization reaction. This contact time is judiciously chosen by a person skilled in the art as a function of the concentration of the reaction medium and of the temperature of the reaction medium. Typically, the functionalization reaction is carried out under stirring, at a temperature ranging from 17° C. to 80° C., for 0.01 to 24 hours.

Once functionalized, the elastomer may be recovered, in particular by isolating it from the reaction medium. The techniques for separating the elastomer from the reaction medium are well known to a person skilled in the art and are chosen by a person skilled in the art depending on the amount of elastomer to be separated, its macrostructure and the tools available to a person skilled in the art. Mention may be made, for example, of the techniques of coagulating the elastomer in a solvent such as methanol, the techniques of evaporating the solvent of the reaction medium and the residual monomers, for example under reduced pressure.

When the functionalizing agent is of formula (IV), (IV-1) or (IV-2) and g is equal to 2, step b) may be followed by a hydrolysis reaction in order to form an elastomer bearing a silanol function at the chain end. The hydrolysis may be carried out by a step of stripping of the solution containing the elastomer at the end of step b), in a manner known to a person skilled in the art.

When the functionalizing agent is of formula (IV), (IV-1), (IV-2), (IV-3) or (IV-4), when g is other than 0 and when Rc² represents a hydrocarbon chain substituted by a function Fc² in a protected form, step b) may also be followed by a hydrolysis reaction in order to deprotect the function at the end of the chain of the elastomer. The hydrolysis reaction, step of deprotecting the function, is generally carried out in an acid or basic medium depending on the chemical nature of the function to be deprotected. For example, a silyl group, in particular trimethylsilyl or tert-butyldimethylsilyl group, which protects an amine or thiol function may be hydrolysed in an acid or basic medium in a manner known to a person skilled in the art. The choice of the deprotection conditions is judiciously made by a person skilled in the art taking into account the chemical structure of the substrate to be deprotected.

Step c) is an optional step depending on whether or not it is desired to convert the functional group into a silanol function or whether or not it is desired to deprotect the protected function. Preferentially, step c) is carried out before separating the elastomer from the reaction medium at the end of step b) or else at the same time as this separation step.

Preferably, the rubber composition contains more than 50 phr of the highly saturated elastomer, more preferentially at least 80 phr of the elastomer useful for the requirements of the invention. Advantageously, the content of the highly saturated elastomer is 100 phr. The highly saturated elastomer may consist of a mixture of elastomers useful for the requirements of the invention which differ from one another in their microstructures or in their macrostructures.

“Reinforcing inorganic filler” should be understood, in the present application, by definition, as meaning any inorganic or mineral filler (regardless of its colour and its origin, natural or synthetic), also known as “white filler”, “clear filler” or indeed even “non-black filler”, in contrast to carbon black, capable of reinforcing by itself alone, without means other than an intermediate coupling agent, a rubber composition intended for the manufacture of tires, in other words capable of replacing, in its reinforcing role, a conventional tire-grade carbon black; such a filler is generally characterized, in a known way, by the presence of hydroxyl (—OH) groups at its surface.

Mineral fillers of the siliceous type, preferably silica (SiO₂), are suitable in particular as reinforcing inorganic fillers. The silica used may be any reinforcing silica known to those skilled in the art, especially any precipitated or fumed silica exhibiting a BET surface area and a CTAB specific surface area both of less than 450 m²/g, preferably from 30 to 400 m²/g, especially between 60 and 300 m²/g. Mention will be made, as highly dispersible precipitated silicas (“HDSs”), for example, of the Ultrasil 7000 and Ultrasil 7005 silicas from Degussa, the Zeosil 1165MP, 1135MP and 1115MP silicas from Rhodia, the Hi-Sil EZ150G silica from PPG, the Zeopol 8715, 8745 and 8755 silicas from Huber or the silicas with a high specific surface area as described in application WO 03/016387.

In the present account, the BET specific surface area is determined in a known way by gas adsorption using the Brunauer-Emmett-Teller method described in The Journal of the American Chemical Society, Vol. 60, page 309, February 1938, more specifically according to French Standard NF ISO 9277 of December 1996 (multipoint (5 point) volumetric method-gas: nitrogen-degassing: 1 hour at 160° C.-relative pressure p/p₀ range: 0.05 to 0.17). The CTAB specific surface area is the outer surface area determined according to French Standard NFT 45-007 of November 1987 (method B).

The physical state under which the reinforcing inorganic filler is provided is not important, whether in the form of a powder, of micropearls, of granules or else of beads. Of course, reinforcing inorganic filler is also understood to mean mixtures of different reinforcing inorganic fillers, in particular of highly dispersible silicas as described above.

A person skilled in the art will understand that use might be made, as filler equivalent to the reinforcing inorganic filler described in the present section, of a reinforcing filler of another nature, in particular organic nature, such as carbon black, provided that this reinforcing filler is covered with an inorganic layer, such as silica, or else includes, at its surface, functional sites, especially hydroxyl sites, requiring the use of a coupling agent in order to establish the bond between the filler and the elastomer. By way of example, mention may be made, for example, of carbon blacks for tires, such as described, for example, in patent documents WO 96/37547 and WO 99/28380.

Preferably, the content of reinforcing inorganic filler is between 30 and 200 phr, more preferentially between 40 and 160 phr. Any one of these ranges of content of reinforcing inorganic filler can apply to any one of the embodiments of the invention.

The rubber composition may further comprise carbon black. All carbon blacks, in particular blacks of the HAF, ISAF, SAF, FF, FEF, GPF and SRF type, conventionally used in rubber compositions for tires (“tire-grade” blacks) are suitable as carbon blacks. The carbon black, when it is present, is preferably used at a content of less than 20 phr, more preferably of less than 10 phr (for example, between 0.5 and 20 phr, in particular between 2 and 10 phr). Within the intervals indicated, the colouring properties (black pigmenting agent) and UV-stabilizing properties of the carbon blacks are beneficial, without, moreover, adversely affecting the typical performance qualities contributed by the reinforcing inorganic filler, in particular silica.

In order to couple the reinforcing inorganic filler to the diene elastomer, use is made, in a well-known way, of an at least bifunctional coupling agent, in particular a silane, (or bonding agent) intended to provide a satisfactory connection between the inorganic filler (surface of its particles) and the diene elastomer. Use is made in particular of organosilanes or polyorganosiloxanes which are at least bifunctional.

Use is made in particular of silane polysulfides, referred to as “symmetrical” or “asymmetrical” depending on their specific structure, such as described, for example, in applications WO 03/002648 (or US 2005/016651) and WO 03/002649 (or US 2005/016650).

Particularly suitable, without the definition below being limiting, are silane polysulfides corresponding to the general formula (V):

Z-G-Sₓ-G-Z (V)
in which:
   x is an integer from 2 to 8 (preferably from 2 to 5);
   the G symbols, which are identical or different, represent a divalent hydrocarbon radical (preferably a C₁-C₁₈ alkylene group or a C₆-C₁₂arylene group, more particularly a C₁-C₁₀, especially C₁-C₄, alkylene, in particular propylene);
   the Z symbols, which are identical or different, correspond to one of the three formulae below:

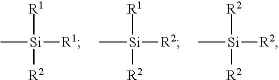

in which:
   the R¹ radicals, which are substituted or unsubstituted and identical to or different from one another, represent a C₁-C₁₈ alkyl, C₅-C₁₈ cycloalkyl or C₆-C₁₈ aryl group (preferably C₁-C₆ alkyl, cyclohexyl or phenyl groups, in particular C₁-C₄ alkyl groups, more particularly methyl and/or ethyl);
   the R² radicals, which are substituted or unsubstituted and identical to or different from one another, represent a C₁-C₁₈ alkoxyl or C₅-C₁₈ cycloalkoxyl group (preferably a group chosen from C₁-C₈ alkoxyls and C₅-C₈ cycloalkoxyls, more preferentially still a group chosen from C₁-C₄ alkoxyls, in particular methoxyl and ethoxyl).

In the case of a mixture of alkoxysilane polysulfides corresponding to the above formula (I), especially customary commercially available mixtures, the mean value of “x” is a fractional number preferably of between 2 and 5, more preferentially close to 4. However, the invention can also advantageously be carried out, for example, with alkoxysilane disulfides (x=2).

Mention will more particularly be made, as examples of silane polysulfides, of bis((C₁-C₄)alkoxyl(C₁-C₄)alkylsilyl(C₁-C₄)alkyl) polysulfides (in particular disulfides, trisulfides or tetrasulfides), such as, for example, bis(3-trimethoxysilylpropyl) or bis(3-triethoxysilylpropyl) polysulfides. Among these compounds, use is made in particular of bis(3-triethoxysilylpropyl) tetrasulfide, abbreviated to TESPT, of formula [(C₂H₅O)₃Si(CH₂)₃S₂]₂, or bis(triethoxysilylpropyl) disulfide, abbreviated to TESPD, of formula [(C₂H₅O)₃Si(CH₂)₃S]₂.

Mention will in particular be made, as coupling agent other than alkoxysilane polysulfide, of bifunctional POSs (polyorganosiloxanes), or else of hydroxysilane polysulfides, such as described in Patent Applications WO 02/30939 (or U.S. Pat. No. 6,774,255) and WO 02/31041 (or US 2004/051210), or else of silanes or POSs bearing azodicarbonyl functional groups, such as described, for example, in Patent Applications WO 2006/125532, WO 2006/125533 and WO 2006/125534.

The content of coupling agent is advantageously less than 30 phr, it being understood that it is generally desirable to use as little as possible thereof. Typically, the content of coupling agent represents from 0.5% to 15% by weight relative to the amount of inorganic filler. Its content is preferentially between 0.5 and 16 phr, more preferentially within a range extending from 3 to 10 phr. This content is readily adjusted by those skilled in the art depending on the content of inorganic filler used in the composition.

The rubber composition in accordance with the invention can also comprise, in addition to the coupling agents, coupling activators, agents for covering the inorganic fillers or more generally processing aids capable, in a known way, by virtue of an improvement in the dispersion of the filler in the rubber matrix and of a lowering of the viscosity of the compositions, of improving their ability to be processed in the raw state.

The rubber composition may contain a crosslinking system. The chemical crosslinking enables the formation of covalent bonds between the elastomer chains. The crosslinking system may be a vulcanization system or one or more peroxide compounds.

The vulcanization system proper is based on sulfur (or on a sulfur-donating agent) and on a primary vulcanization accelerator. Various known secondary vulcanization accelerators or vulcanization activators, such as zinc oxide, stearic acid or equivalent compounds, or guanidine derivatives (in particular diphenylguanidine), are added to this base vulcanization system, being incorporated during the non-productive first phase and/or during the productive phase, as described subsequently. The sulfur is used at a preferential content of 0.5 to 12 phr, in particular of 1 to 10 phr. The primary vulcanization accelerator is used at a preferential content of between 0.5 and 10 phr, more preferentially of between 0.5 and 5 phr. Use may be made, as (primary or secondary) accelerator, of any compound capable of acting as accelerator of the vulcanization of diene elastomers in the presence of sulfur, in particular accelerators of the thiazole type and also their derivatives, or accelerators of thiuram or zinc dithiocarbamate types. Preferably, use is made of a primary accelerator of the sulfenamide type.

When the chemical crosslinking is carried out using one or more peroxide compounds, said peroxide compound or compounds preferably represent from 0.01 to 10 phr. Mention may be made, as peroxide compounds which can be used as chemical crosslinking system, of acyl peroxides, for example benzoyl peroxide or p-chlorobenzoyl peroxide, ketone peroxides, for example methyl ethyl ketone peroxide, peroxyesters, for example t-butyl peroxyacetate, t-butyl peroxybenzoate and t-butyl peroxyphthalate, alkyl peroxides, for example dicumyl peroxide, di(t-butyl) peroxybenzoate and 1,3-bis(t-butylperoxyisopropyl)benzene, or hydroperoxides, for example t-butyl hydroperoxide.

The rubber composition may contain, in addition to the highly saturated elastomer, a second elastomer. The second elastomer may be selected from the group of diene elastomers consisting of polybutadienes, polyisoprenes, butadiene copolymers, isoprene copolymers and their mixture.

The rubber composition in accordance with the invention may also comprise all or some of the usual additives normally used in elastomer compositions intended to constitute external mixtures of finished rubber articles, such as tires, in particular treads, such as for example plasticizers or extender oils, whether these are aromatic or non-aromatic in nature, in particular very weakly aromatic or non-aromatic oils (e.g., liquid paraffins, hydrogenated naphthenic oils, MES or TDAE oils), vegetable oils, in particular glycerol esters such as glyceryl trioleates, pigments, protective agents such as anti-ozone waxes, chemical anti-ozonants, antioxidants.

The rubber composition according to the invention can be manufactured in appropriate mixers, using two successive phases of preparation according to a general procedure well known to those skilled in the art: a first phase of thermomechanical working or kneading (sometimes referred to as “non-productive” phase) at high temperature, up to a maximum temperature of between 130° C. and 200° C., preferably between 145° C. and 185° C., followed by a second phase of mechanical working (sometimes referred to as “productive” phase) at lower temperature, typically below 120° C., for example between 60° C. and 100° C., during which finishing phase the chemical crosslinking agent, in particular the vulcanization system, is incorporated.

Generally, all the base constituents of the composition included in the tire of the invention, with the exception of the crosslinking system, namely the reinforcing inorganic filler and the coupling agent, if appropriate, are intimately incorporated, by kneading, into the diene elastomer during the first “non-productive” phase, that is to say that at least these various base constituents are introduced into the mixer and are thermomechanically kneaded, in one or more steps, until the maximum temperature of between 130° C. and 200° C., preferably of between 145° C. and 185° C., is reached.

By way of example, the first (non-productive) phase is carried out in a single thermomechanical step during which all the necessary constituents, the optional supplementary processing aids and various other additives, with the exception of the chemical crosslinking agent, are introduced into an appropriate mixer, such as a standard internal mixer. The total duration of the kneading, in this non-productive phase, is preferably between 1 and 15 min. After cooling the mixture thus obtained during the first non-productive phase, the crosslinking system is then incorporated at low temperature, generally in an external mixer, such as an open mill; everything is then mixed (productive phase) for a few minutes, for example between 2 and 15 min.

The final composition thus obtained is subsequently calendered, for example in the form of a sheet or a slab, especially for laboratory characterization, or else extruded in the form of a rubber profiled element which can be used as semi-finished tire product for a vehicle.

Thus, according to a specific embodiment of the invention, the rubber composition in accordance with the invention, which can either be in the uncured state (before crosslinking or vulcanization) or in the cured state (after crosslinking or vulcanization), is a semi-finished product which may be used in a tire, especially as a tire tread.

A better understanding of the abovementioned characteristics of the present invention, and also others, will be obtained on reading the following description of several exemplary embodiments of the invention, given by way of illustration and without limitation.

### II. EXEMPLARY EMBODIMENTS OF THE INVENTION

II.1—Characterization Methods:

Size Exclusion Chromatography (SEC):

a) Principle of the Measurement:

Size exclusion chromatography or SEC makes it possible to separate macromolecules in solution according to their size through columns filled with a porous gel. The macromolecules are separated according to their hydrodynamic volume, the bulkiest being eluted first.

Combined with 3 detectors (3D), a refractometer, a viscometer and a 90° light scattering detector, SEC makes it possible to learn the absolute molar mass distribution of a polymer. The various number-average (Mn) and weight-average (Mw) absolute molar masses and the polydispersity index (PI=Mw/Mn) can also be calculated.

b) Preparation of the Polymer:

There is no specific treatment of the polymer sample before analysis. Said sample is simply dissolved, in tetrahydrofuran+1 vol % of diisopropylamine+1 vol % of triethylamine, at a concentration of approximately 1 g/I. The solution is then filtered through a filter with a porosity of 0.45 μm before injection.

c) SEC3D Analysis:

The apparatus used is a Waters Alliance chromatograph. The elution solvent is tetrahydrofuran+1 vol % of diisopropylamine+1 vol % of triethylamine, the flow rate is 0.5 ml/min, and the system temperature is 35° C. Use is made of a set of four Polymer Laboratories columns in series, two with the “Mixed A LS” trade name and two with the “Mixed B LS” trade name.

The volume of the solution of the polymer sample injected is 100 The detection system used is the TDA 302 from Viscotek, it is composed of a differential refractometer, a differential viscometer and a 90° light scattering detector. For these 3 detectors, the wavelength is 670 nm. For the calculation of the average molar masses, the value of the refractive index increment dn/dC of the polymer solution is integrated, said value being defined beforehand in tetrahydrofuran+1 vol % of diisopropylamine+1 vol % of triethylamine, at 35° C. and 670 nm. The software for evaluating the data is the Omnisec system from Viscotek.

### Nuclear Magnetic Resonance (NMR):

All the functionalization products of the copolymers of ethylene and 1,3-butadiene are characterized by ¹H, ¹³C, ²⁹Si NMR spectrometry. The NMR spectra are recorded on a Bruker Avance III 500 MHz spectrometer equipped with a 5 mm BBI Z-grad “broad band” cryoprobe. The quantitative ¹H NMR experiment uses a simple 30° pulse sequence and a repetition time of 5 seconds between each acquisition. 64 to 256 accumulations are carried out. The quantitative ¹³C NMR experiment uses a 30° single pulse sequence with a proton decoupling and a repetition time of 10 seconds between each acquisition. 1024 to 10240 accumulations are carried out. The determination of the microstructure of the copolymers is defined in the literature, according to the article by Llauro et al., Macromolecules 2001, 34, 6304-6311. This method was supplemented in the specific case of terpolymers possessing styrene moieties, as described below.

The ¹H NMR spectrum makes it possible to quantify the styrene, 1,3-butadiene and ethylene units.

The edited 2D ¹H/¹³C 1J HSQC NMR correlation spectrum makes it possible to verify the nature of the moieties owing to the chemical shifts of the carbon atom and proton signals.

3J HMBC ¹H/¹³C long-distance correlation spectra make it possible to verify the presence of covalent bonds between the styrene, 1,3-butadiene and ethylene units.

The assignment of the protons which are used for the quantification is given in Table 1.

TABLE 1
Chemical shifts observed for the quantification of the samples
The chemical shifts are calibrated with
respect to the protonated impurity of chloroform
(δ ppm ¹H at 7.20 ppm and δ ppm ¹³C at 77.0 ppm).

| Number of | δ ppm | Units |
|---|---|---|
| protons | (¹H) | quantified |
| 5 | 6.5 to 8 | 5 aromatic H of the styrene unit |
| 1 + 2 | 4.96 to 5.60 | 1 ethylenic H of the 1,2-PB + 2 ethylenic H |
| | | of the 1,4-PB |
| 2 | 4.6 to 4.96 | 2 ethylenic H of the 1,2-PB |
| 4 | 0.2-3.0 | 4 H of the ethylene unit + 3 aliphatic H of |
| | | the styrene unit + 3 H of the 1,2-PB + 4 |
| | | H of the 1,4-PB |

1,2-PB: unit of the 1,3-butadiene resulting from a 2,1-insertion (1,2-unit)
1,4-PB: unit of the 1,3-butadiene resulting from a 1,4-insertion (1,4-unit)
Information on the cis and trans microstructure of the 1,4-PB units can be obtained from the quantitative ¹D ¹³C NMR spectrum.

Two-dimensional ¹H/¹³C and ¹H/²⁹Si experiments are used with the aim of determining the structure of the functional polymers.

The final chemical structure of each functional polymer is identified by ¹H, ¹³C and ²⁹Si NMR.

Dynamic Properties:

The dynamic properties are measured on a viscosity analyser (Metravib VA4000) according to standard ASTM D 5992-96. The response of a sample of vulcanized composition (cylindrical test specimen with a thickness of 4 mm and a cross section of 400 mm²), subjected to a simple alternating sinusoidal shear stress, at a frequency of 10 Hz, under standard temperature conditions (23° C.) according to standard ASTM D 1349-99, is recorded. A strain amplitude sweep is carried out from 0.1% to 50% (outward cycle) and then from 50% to 0.1% (return cycle). The results made use of are the complex shear modulus G*, the loss factor tan(δ) and the difference in modulus ΔG* between the values at 0.1% and 50% strain (Payne effect). For the return cycle, the maximum value of tan(δ) observed, denoted by tan(δ)max, is indicated. The complex modulus G* at 50% strain, denoted by G*, the difference in modulus ΔG* between the values at 0.1% and 50% strain (Payne effect) and the value of tan(δ)max are given in base 100, the value 100 being assigned to the control composition (C). The lower the value of ΔG*, the lower the non-linearity. The lower the value of tan(δ)max, the lower the hysteresis of the rubber composition. The lower the value of G*, the lower the stiffness of the composition.

The response of a sample of composition subjected to a simple alternating sinusoidal shear stress during a temperature sweep; subjected to a sinusoidal stress at an imposed load of 0.7 MPa and at a frequency of 10 Hz, the temperature ranging from −60° C. to 100° C., at a rate of 1.5° C. per minute, is also recorded. The Tg of the mixture is indicated by the temperature of the maximum of tan(δ), denoted “Tg (° C.) tan(δ) max”. Another result made use of is the complex dynamic shear modulus (G*), denoted by G* Modulus, for example at 60° C. For greater readability, the G* results will be shown in base 100, the value 100 being assigned to the control. A result of less than 100 indicates a decrease in the value concerned and, conversely, a result of greater than 100 will indicate an increase in the value concerned.

II.2—Preparation of the Copolymers in Accordance with the Invention:

Raw Materials

All the reactants are obtained commercially except for the metallocenes [{Me₂SiFlu₂Nd(μ-BH₄)₂Li(THF)}₂] (metallocene A) and [{Me₂SiCpFluNd(μ-BH₄)₂Li(THF)}₂] (metallocene B) (Cp and Flu respectively denoting C₆H₄ and C₈H₁₃) which may be prepared according to the procedures described in documents WO 2007054224 and WO 2007054223.

The butyloctylmagnesium BOMAG (20% in heptane, C=0.88 mol·l⁻¹) originates from Chemtura and is stored in a Schlenk tube under an inert atmosphere. The ethylene, of N35 grade, originates from Air Liquide and is used without prepurification. The 1,3-butadiene is purified over alumina guards. The functionalizing agents are used without prepurification. The (N,N-dimethyl-3-aminopropyl)methyldimethoxysilane (AB252529), originates from ABCR and the (N,N-dimethylaminopropyl)trimethoxysilane originates from Nitrochemie.

The methylcyclohexane solvent originating from BioSolve is dried and purified on an alumina column in a solvent purifier originating from mBraun used in an inert atmosphere. The methanol (99%, class 3, grade II) originates from Laurylas, the C₆D₆ (99.6 atom % D) from Aldrich and is stored at low temperature. All the reactions are carried out in an inert atmosphere.

Equipment

All the polymerizations and the functionalization reactions of copolymers of ethylene and 1,3-butadiene or of terpolymers of ethylene, 1,3-butadiene and styrene are carried out in a reactor having a disposable 500 ml glass tank (Schott flasks) equipped with a stainless steel stirrer blade. The control of the temperature is ensured by means of a thermostatically-controlled oil bath connected to a polycarbonate jacket. This reactor has all the inlets or outlets necessary for the handling operations.

Polymerization Procedure

30 mg of metallocene are introduced into a first Steinie bottle in a glovebox. The butyloctylmagnesium, dissolved beforehand in 300 ml of methylcyclohexane in a second Steinie bottle, is introduced into the first Steinie bottle containing the metallocene in the proportions indicated in Table 2. After 10 minutes of contact at ambient temperature a catalytic solution is obtained. The catalytic solution is then introduced into the polymerization reactor.

In the case of the metallocene A, [{Me₂SiFlu₂Nd(μ-BH₄)₂Li(THF)}₂], the temperature in the reactor is then increased to 80° C. When this temperature is reached, the reaction starts by injection of a gaseous mixture of ethylene (Eth) and 1,3-butadiene (But) (80/20 mol %) into the reactor. The polymerization reaction takes place at a pressure of 4 bar except in the case of Example 6 where it takes place at 8 bar.

In the case of the metallocene B, [{Me₂SiCpFluNd(μ-BH₄)₂Li(THF)}₂], the temperature in the reactor is then increased to 50° C. When this temperature is reached, the reaction starts by injection of a gaseous mixture of ethylene (Eth) and 1,3-butadiene (But) into the reactor in the proportions defined in Table 2. The polymerization reaction takes place at a pressure of 4 bar.

During the synthesis of the terpolymer of ethylene, 1,3-butadiene and styrene with this metallocene, the styrene is injected into the polymerization reactor just after the introduction of the catalytic solution.

Functionalization Procedure

When the desired monomer conversion is achieved, the content of the reactor is degassed then the functionalizing agent is introduced under an inert atmosphere by excess pressure. The reaction medium is stirred for a time and temperature which are indicated in Table 2. After reaction, the medium is degassed then precipitated out in methanol. The polymers are redissolved in toluene, then precipitated out into methanol so as to eliminate the ungrafted “silane” molecules, which makes it possible to improve the quality of the signals of the spectra for the quantification of the functional group content and the integration of the various signals. The polymer is treated with antioxidant then dried at 60° C. under vacuum to constant weight. It is then analyzed by SEC (THF), ¹H, ¹³C, ²⁹Si NMR.

The functionalizing agents used respectively:

| | |
|---|---|
| (N,N-dimethyl-3-aminopropyl)methyldimethoxysilane | A1 |
| (N,N-dimethyl-3-aminopropyl)trimethoxysilane | A2 |

The experimental conditions of the functionalization reaction are described in Table 2.

### Procedure for the Preparation of the Rubber Compositions

Rubber compositions, of which the formulation expressed in phr (parts by weight per hundred parts of elastomer) appears in Table 3, were prepared according to the following procedure: the copolymer, the silica, and also the various other ingredients, with the exception of the vulcanization system, are successively introduced into an internal mixer (final degree of filling: approximately 70% by volume), the initial vessel temperature of which is approximately 80° C. Thermomechanical working (non-productive phase) is then carried out in one step, which lasts in total approximately 5 min, until a maximum “dropping” temperature of 150° C. is reached. The mixture thus obtained is recovered and cooled and then sulfur and the accelerator are incorporated on a mixer (homofinisher) at 40° C., everything being mixed (productive phase) for approximately ten minutes. The compositions thus obtained are subsequently calendered, either in the form of slabs (thickness of 2 to 3 mm) or of thin sheets of rubber for the measurement of their physical or mechanical properties.

II.3—Results:

The results appear in Tables 4 and 5.

Independently of the functionalizing agent and of the metallocene that are used, the copolymer has an alkoxysilane or silanol functionalization at the chain end. A third, or even half, of the chains may be functionalized, as is the case when the functionalizing agents A1 and A2 are used with the metallocene A. In the case of the use of the metallocene B with the functionalizing agents A1 and A2, the contents of functional groups may reach more than 90%.

The values of ΔG* and Tan δ max of the composition I which comprises a copolymer in accordance with the invention are much lower than those of the control composition C. At the same time, the value of G* is also lower. The rubber composition in accordance with the invention simultaneously has lower hysteresis and is less stiff than the control composition.

TABLE 2

| | | | | | | | Functionalizing | | Polymerization and |
|---|---|---|---|---|---|---|---|---|---|
| | | Metallocene | Cocatalyst | Eth/But | Styrene | Functionalizing | agent/cocatalyst | Functionalization | functionalization |
| Example | Metallocene | (mol/l) | (mol/l) | (mol %) | (ml) | agent | ratio | time (min) | temperature (° C.) |
| 1 | A | 0.00015 | 0.00075 | 80/20 | — | A1 | 2 | 15 | 80 |
| 2 | A | 0.00016 | 0.00081 | 80/20 | — | A2 | 4 | 60 | 80 |
| 3 | B | 0.00026 | 0.00094 | 80/20 | — | A1 | 4 | 60 | 50 |
| 4 | B | 0.00019 | 0.0011 | 80/20 | — | A2 | 4 | 60 | 50 |
| 5 | B | 0.00019 | 0.0011 | 90/10 | 20 | A1 | 4 | 60 | 40 |
| 6 | A | 0.00007 | 0.0004 | 80/20 | — | A1 | 4 | 15 | 80 |

TABLE 3

| Composition (phr) | C | I |
|---|---|---|
| EBR (1) | 100 | — |
| EBR (2) | — | 100 |
| Antioxidant (3) | 2 | 2 |
| Stearic acid | 2 | 2 |
| ZnO | 1 | 1 |
| Accelerator (4) | 2 | 2 |
| Sulfur | 1 | 1 |
| N234 | 3 | 3 |
| Silica (5) | 55 | 55 |
| Antiozone wax | 1.6 | 1.6 |
| Silane (6) | 4 | 4 |
| DPG (7) | 1.5 | 1.5 |

(1) Copolymer of ethylene and 1,3-butadiene with 79 mol % of ethylene units and 7 mol % of 1,2-cyclohexanediyl units (non-functional)
(2) Copolymer of ethylene and 1,3-butadiene with 77 mol % of ethylene units and 9 mol % of 1,2-cyclohexanediyl units which is functionalized at the chain end, functional group content 35%, functionalizing agent N,N-dimethyl-3-aminopropyl)methyldimethoxysilane
(3) N-(1,3-Dimethylbutyl)-N′-phenyl-p-phenylenediamine (Santoflex 6-PPD from Flexsys)
(4) N-cyclohexyl-2-benzothiazolesulfenamide (Santocure CBS from Flexsys)
(5) Zeosil 1165 MP, Solvay-Rhodia, in the form of micropearls
(6) TESPT (Si69), Evonik-Degussa
(7) Diphenylguanidine

TABLE 4

| | | | | | 1,2- | | |
|---|---|---|---|---|---|---|---|
| | Mn | Ethylene | 1,2-Butadiene | 1,4-Butadiene | Cyclohexanediyl | Styrene | Functional group |
| Example | (g/mol) | (mol %) | (mol %) | (mol %) | (mol %) | (mol %) | content (%) |
| 1 | 30100 | 76.7 | 6 | 5.4 | 11.9 | — | 33 |
| 2 | 41800 | 78 | 6 | 5 | 11 | — | 48 |
| 3 | 11265 | 56.8 | 1 | 42 | 0.2 | — | 98 |
| 4 | 16150 | 69 | 1 | 30 | 0 | — | 91 |
| 5 | 28160 | 62.5 | 0.5 | 10 | 0 | 27 | 44 |
| 6 | 139400 | 76.7 | 9 | 5.6 | 8.7 | — | 35 |

TABLE 5

| Properties in the cured state | C | I |
|---|---|---|
| ΔG* 23° C. | 100 | 51 |
| Tanδ max 23° C. | 100 | 82 |
| G* 23° C. | 100 | 79 |
| Modulus G* | 100 | 88 |

1. A rubber composition which comprises at least one reinforcing inorganic filler and a highly saturated elastomer comprising 1,3-diene units and ethylene units and bearing, at the chain end, a functional group F¹ which is a silanol or alkoxysilane function, the ethylene units representing more than 50 mol % of all the monomer units of the elastomer.

2. A rubber composition according to claim 1, in which the ethylene units represent more than 60 mol % of all the monomer units of the elastomer.

3. A rubber composition according to claim 1, in which the 1,3-diene is 1,3-butadiene.

4. A rubber composition according to claim 1, in which the elastomer contains UD units of formula (I):

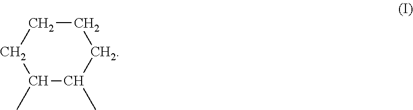

5. A rubber composition according to claim 4, in which the elastomer contains the following UA units, UB units, UC units, UD units and UE units distributed randomly:
UA) —CH₂—CH₂— according to a molar percentage of m %
UB) —CH₂—CH═CH—CH₂— according to a molar percentage of n %
UC) —CH₂—CH(CH═CH₂)— according to a molar percentage of o % 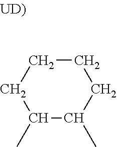
according to a molar percentage of p % 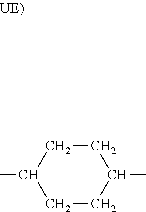
according to a molar percentage of q %
m, n, o, p and q being numbers ranging from 0 to 100,
m>50
n+o>0
p>0
q≥0,
the respective molar percentages of m, n, o, p and q being calculated on the basis of the sum of m+n+o+p+q, which is equal to 100.

6. A rubber composition according to claim 5, in which:
0<o+p≤25
o+p+q≥5
n+o>0
q≥0,
the respective molar percentages of m, n, o, p and q being calculated on the basis of the sum of m+n+o+p+q, which is equal to 100.

7. A rubber composition according to claim 5, in which q is equal to 0.

8. A rubber composition according to claim 1, in which the elastomer contains trans-1,4-units which represent more than 80 mol % of the 1,3-diene units of the elastomer.

9. A rubber composition according to claim 8, in which the elastomer comprises α-monoolefin units distributed randomly within the elastomer.

10. A rubber composition according to claim 1, in which the elastomer is a copolymer of 1,3-butadiene and ethylene or a terpolymer of 1,3-butadiene, ethylene and an α-monoolefin.

11. A rubber composition according to claim 9, in which the α-monoolefin is styrene, a styrene substituted by one or more alkyl groups in the para, meta or ortho positions, or mixtures thereof.

12. A rubber composition according to claim 1, in which the functional group F¹ is attached directly via a covalent bond to the end unit of the elastomer, the Si atom being bonded to the methylene:

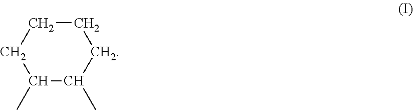

13. A rubber composition according to claim 1, in which the functional group F¹ is of formula (III-a) or (III-b):
Si(OR¹)_{3-f}(R²)_{f} (III-a)
Si(OH)(R²)₂ (III-b)
the R¹ symbols, which are identical or different, representing an alkyl,
the R² symbols, which are identical or different, representing a hydrogen atom, a hydrocarbon chain or a hydrocarbon chain substituted by a chemical function F²,
f being an integer ranging from 0 to 2.

14. A rubber composition according to claim 13, in which the R¹ symbols are an alkyl having at most 6 carbon atoms.

15. A rubber composition according to claim 13, in which the R² symbols represent an alkyl having at most 6 carbon atoms or an alkanediyl chain having at most 6 carbon atoms and substituted by a chemical function F².

16. A rubber composition according to claim 13, in which the alkyl represented by the R¹ and R² symbols is a methyl or an ethyl.

17. A rubber composition according to claim 13, in which the chemical function F² is a primary, secondary or tertiary amine function or a thiol function, the primary or secondary amine or thiol function being protected by a protecting group or being unprotected.

18. A rubber composition according to claim 17, in which the protecting group is a silyl group.

19. A rubber composition according to claim 1, in which the functional group F¹ is dimethoxymethylsilyl, dimethoxyethylsilyl, diethoxymethysilyl, diethoxyethysilyl, 3-(N,N-dimethylamino)propyldimethoxysilyl, 3-(N,N-dimethylamino)propyldiethoxysilyl, 3-aminopropyldimethoxysilyl, 3-aminopropyldiethoxysilyl, 3-thiopropyldimethoxysilyl, 3-thiopropyldiethoxysilyl, methoxydimethylsilyl, methoxydiethylsilyl, ethoxydimethysilyl, ethoxydiethysilyl, 3-(N,N-dimethylamino)propylmethoxymethylsilyl, 3-(N,N-dimethylamino)propylmethoxyethylsilyl, 3-(N,N-dimethylamino)propylethoxymethylsilyl, 3-(N,N-dimethylamino)propylethoxyethylsilyl, 3-aminopropylmethoxymethylsilyl, 3-aminopropylmethoxyethylsilyl, 3-aminopropylethoxymethylsilyl, 3-aminopropylethoxyethylsilyl, 3-thiopropylmethoxymethylsilyl, 3-thiopropylethoxymethylsilyl, 3-thiopropylmethoxyethylsilyl, or 3-thiopropylethoxyethylsilyl, or the protected form of the amine or thiol function of 3-aminopropyldimethoxysilyl, 3-aminopropyldiethoxysilyl, 3-thiopropyldimethoxysilyl, 3-thiopropyldiethoxysilyl, 3-aminopropylmethoxymethylsilyl, 3-aminopropylmethoxyethylsilyl, 3-aminopropylethoxymethylsilyl, 3-aminopropylethoxyethylsilyl, 3-thiopropylmethoxymethylsilyl, 3-thiopropylethoxymethylsilyl, 3-thiopropylmethoxyethylsilyl, or 3-thiopropylethoxyethylsilyl.

20. A rubber composition according to claim 1, in which the functional group F¹ is dimethylsilanol, diethylsilanol, 3-(N,N-dimethylamino)propylmethylsilanol, 3-(N,N-dimethylamino)propylethylsilanol, 3-aminopropylmethylsilanol, 3-aminopropylethylsilanol, 3-thiopropylethylsilanol, or 3-thiopropylmethylsilanol, or the protected form of the amine or thiol function of 3-aminopropylmethylsilanol, 3-aminopropylethylsilanol, 3-thiopropylethylsilanol, or 3-thiopropylmethylsilanol.

21. A rubber composition according to claim 1, in which the functional group F¹ is of formula (III-a) in which f is equal to 1.

22. A rubber composition according to claim 1, in which the content of the highly saturated elastomer is greater than 50 phr.

23. A rubber composition according to claim 1, in which the content of the highly saturated elastomer is 100 phr.

24. A rubber composition according to claim 1, in which the reinforcing inorganic filler is a silica.

25. A rubber composition according to claim 1, which further comprises a coupling agent for coupling the reinforcing inorganic filler to the elastomer.

26. A rubber composition according to claim 1, which further comprises a crosslinking system.

27. A semi-finished article which comprises a rubber composition defined according to claim 1.

28. A tire which comprises a rubber composition defined according to claim 1.
